(19) United States
(12) Patent Application Publication
(10) Pub. No.: US 2011/0080449 A1
(43) Pub. Date: Apr. 7, 2011

(54) Non-wetting Coating on Die Mount

(75) Inventors: Kevin von Essen, San Jose, CA (US); John A. Higginson, Santa Clara, CA (US); Andreas Bibl, Los Altos, CA (US)

(73) Assignee: FUJIFILM Corporation

(21) Appl. No.: 12/572,929

(22) Filed: Oct. 2, 2009

(51) Int. Cl. B41J 2/165; B41J 2/135; B32B 37/02

(52) U.S. Cl. 347/33; 347/45; 156/60; 156/273.3

(57) ABSTRACT

Printing devices are described that have a printing die with a coplanar adjacent layer. The coplanar adjacent layer is sufficiently non-wetting to fluids that the layer can be easily wiped clean of fluid that is inadvertently deposited thereon. A non-stick surface is optionally applied to the adjacent layer which can withstand both mechanical and chemical abrasion that can be caused by corrosive ejection fluids or wiping mechanisms.

### TECHNICAL FIELD

This disclosure relates to fluid ejection devices.

### BACKGROUND

In some implementations of a fluid droplet ejection device, a substrate, such as a silicon substrate, includes a fluid pumping chamber, a descender, and a nozzle formed therein. Fluid droplets can be ejected from the nozzle onto a receiver, such as in a printing operation. The nozzle is fluidly connected to the descender, which is fluidly connected to the fluid pumping chamber. The fluid pumping chamber can be actuated by a transducer, such as a thermal or piezoelectric actuator, and when actuated, the fluid pumping chamber can cause ejection of a fluid droplet through the nozzle. The receiver can be moved relative to the fluid ejection device. The ejection of a fluid droplet from a nozzle can be timed with the movement of the receiver to place a fluid droplet at a desired location on the receiver. Fluid ejection devices typically include multiple nozzles, and it is usually desirable to eject fluid droplets of uniform size and speed, and in the same direction, to provide uniform deposition of fluid droplets on the receiver. To keep the ejection device claim, wiper blades are often used to clear the fluid from the ejection device.

### SUMMARY

In one aspect, a fluid ejection device is described that has a mounting frame having a wing structure, a fluid ejection die bonded to the mounting frame and a cover on the wing structure. The die is adjacent to the wing structure and has nozzles in a nozzle surface. The cover has a surface with a non-wetting coating and the surface is co-planar with the nozzle surface of the die.

In one aspect, a method of forming a fluid ejection device is described. The method includes forming a non-wetting coating on a substrate, bonding the substrate onto a mounting frame and bonding a die having a nozzle surface onto the mounting frame. A surface of the substrate on which the non-wetting coating is located and the nozzle surface of the die are substantially co-planar.

In another aspect, a method of using a fluid ejection device is described. The method includes wiping a nozzle surface of a die with a wiper blade, wherein the nozzle surface is co-planar with a cover on a mounting frame in which the die is located and the cover has a non-wetting coating thereon.

Implementations of the device and techniques can include one or more of the following. The cover can be adhered to the wing structure with a bonding agent. A gap can be between an edge of the die and the cover filled with a filler and the filler, the nozzle surface of the die and the cover can form a surface that is substantially planar. The mounting frame can have two wing structures, a first of which is adjacent to a first edge of the die and a second of which is adjacent to a second edge of the die opposite to the first edge. The non-wetting coating can be a different material than the cover. The cover can be formed of silicon. The non-wetting coating can include one of tridecafluoro 1,1,2,2 tetrahydrooctyltrichlorosilane (FOTS), 1H,1H,2H,2H perfluorodecyl-trichlorosilane (FDTS), 3,3,3-trifluoropropyltrichlorosilane (CF₃(CH₂)₂SiCl₃) or 3,3,3,4,4,5,5,6,6-nonafluorohexyltrichlorosilane (CF₃(CF₂)₃(CH₂)₂SiCl₃). Individual wing covers can be formed from the substrate prior to bonding the substrate onto the mounting frame. The substrate can be a silicon substrate. A non-wetting coating can be formed on a substrate includes oxygen plasma treating the silicon substrate. A gap between the die and the substrate can be filled with a filler to form a planar surface.

Advantages of the devices shown herein may include one or more of the following. A planar surface can be created on the bottom of the fluid ejection device, and the planar surface can be wiped for uniform cleaning. A smooth surface can prevent fluid from mechanically adhering to the surface of the wing cover and makes it easier to remove the fluid from the surface, unlike a wing cover having a high surface roughness. A non-stick coating can allow fluid to be more easily removed from the surface. The non-stick coating may also be easier to wipe because the wiping blade can more easily glide along the coating surface. A smooth layer under the non-wetting coating can provide a smoother surface for the wiper blade to move along. A filler between the die and the assembly components next to the die can result in a planar surface for wiping that is free from gaps. Thus, fluid has fewer places to collect and can be more easily removed from a fluid ejection device. Particularly difficult to remove materials, such as latex, can be easier to remove than without a non-stick coating. This can result in a cleaner device. A cleaner device can be less prone to non-uniform fluid ejection directionality due to dried fluid partially clogging ejection nozzles. A cleaner device can also result in fewer non-functioning nozzles. The combination of certain application surfaces and non-stick coatings that are applied to the application surface can result in a coating that is sufficiently durable to withstand both wiper blade mechanical abrasion and chemical abrasion, such as from corrosive ejection fluids. Thus, the non-stick coating can have longevity.

The details of one or more implementations of the invention are set forth in the accompanying drawings and the description below. Other features, objects, and advantages of the invention will be apparent from the description and drawings, and from the claims.

### DESCRIPTION OF DRAWINGS

FIG. 1 is a perspective cross sectional view of a fluid ejection assembly.

FIG. 2 is a perspective view of a fluid ejection die and mounting frame.

FIG. 3 is a perspective view of a fluid ejection die, mounting frame and wing cover.

FIG. 4 is a flow diagram describing how to form the assembly.

FIG. 5 is a perspective view of an assembly in a housing.

Like reference symbols in the various drawings indicate like elements.

### DETAILED DESCRIPTION

During fluid ejection, fluid can spray from the ejection nozzles or splash from the receiver on which the fluid is ejected back onto the ejection device. In addition, during fluid purge out of the ejection nozzles, excessive amounts of fluid can exit the device. Some of this fluid can end up on the device itself, rather than being transferred entirely to a purging receptacle. While wiper blades can be used to clear fluid from the ejection device, the wiper blades will not be completely effective if they cannot make continuous contact with the surface that they wipe. In addition, the wiper blades perform better on a smooth surface. For example, the wiper blades will not stick while wiping. Forming smooth wiping surfaces that are coated with non-stick materials can enable complete wiping with reduced possibilities of damaging the wiper blades or the coating itself.

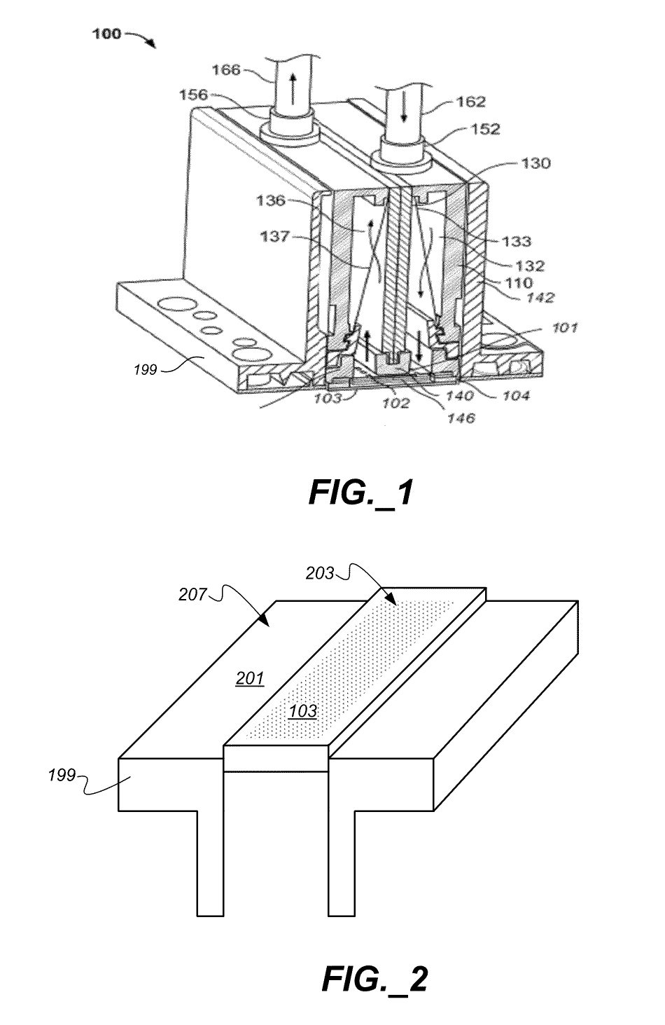

Referring to FIG. 1, an implementation of a fluid ejector 100 includes a fluid ejection module, e.g. a quadrilateral plate-shaped printhead module, which can be a die fabricated using semiconductor processing techniques. The fluid ejection module includes a die 103 in which a plurality of fluid paths are formed, and a plurality of actuators to individually control ejection of fluid from nozzles of the flow paths.

The fluid ejector 100 can also include an inner housing 110 and an outer housing 142 to support the printhead module, a mounting frame 199 to connect the inner housing 110 and outer housing 142 to a print bar, and a flexible circuit, or flex circuit (not shown, but between inner housing 110 and outer housing 142) and associated printed circuit board to receive data from an external processor and provide drive signals to the die. The outer housing 142 can be attached to the inner housing 110 such that a cavity is created between the two. The outer housing 142 and mounting frame 199 can be formed of two L-shaped parts. The die 103 sits between the two L-shaped parts, in a cavity between the two parts and adjacent to the mounting frame 199 of the outer 142 housing.

The inner housing 110 can be divided by a dividing wall 130 to provide an inlet chamber 132 and an outlet chamber 136. Each chamber 132 and 136 can include a filter 133 and 137. Tubing 162 and 166 that carries the fluid can be connected to the chambers 132 and 136, respectively, through apertures 152, 156. The dividing wall 130 can be held by a support 140 that sits on an interposer assembly 146 above the die 103. The support 140 can also be configured to seal a cavity in the fluid ejector 100 and to provide a bonding area for components of the fluid ejector that are used in conjunction with the die 103. The fluid ejector 100 further includes fluid inlets 101 and fluid outlets 102 for allowing fluid to circulate from the inlet chamber 132, through the die 103, and into the outlet chamber 136.

Referring to FIG. 2, the bottom surface of die 103, which includes nozzles 203, extends beyond a bottom surface 201 of mounting frame 199 (only the die and outer housing/mounting frame are shown for the sake of simplicity). That is, the bottom of die 103 is not co-planar with the bottom surface 201 of the mounting frame 199. Because outer housing is formed of the two L-shaped portions, each portion only extends along one side of the die. The extending portions of the mounting frame 199 can be referred to as wings 207.

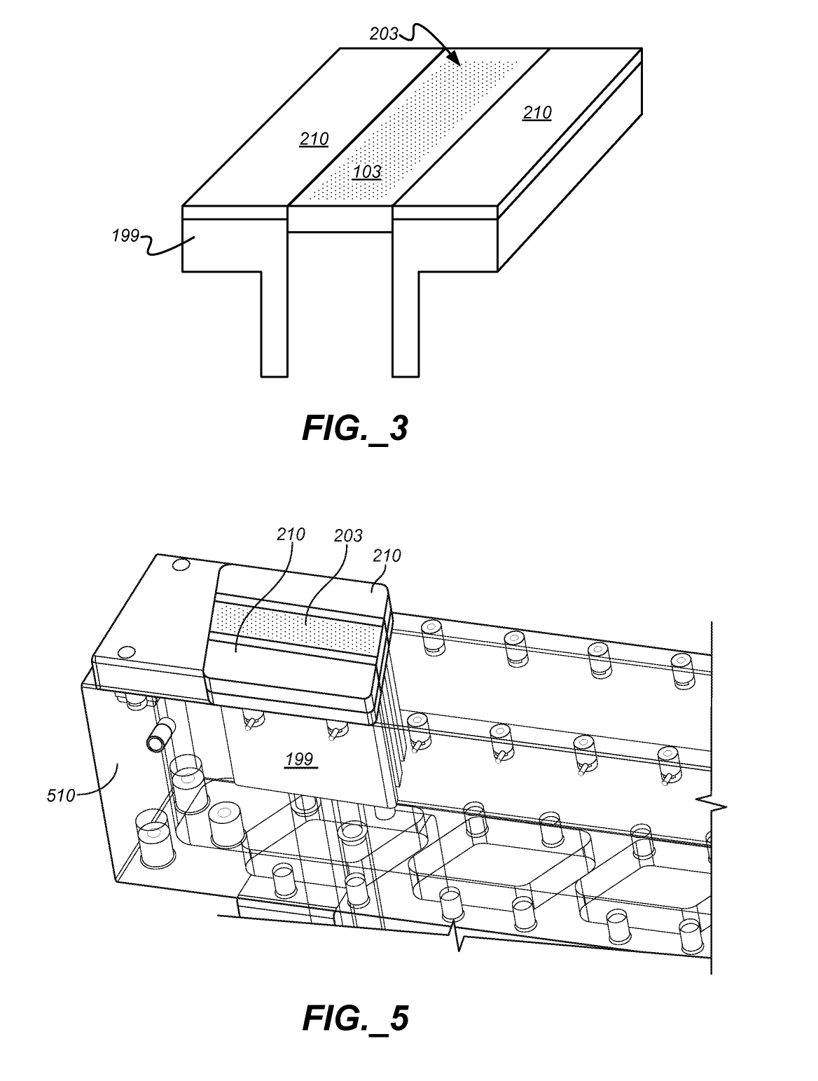

To bring the bottom surface of the wings 207 up to be planar with the nozzle surface of the die 103, a wing cover 210 is attached to the bottom surface 201 of the mounting frame 199, as shown in FIG. 3. Because the mounting frame 199 has a section on either side of the die 103 that requires leveling, two separate wing cover 210 can be adhered to the bottom surface of the mounting frame 199. The thickness of the wing covers is equal to a distance beyond the bottom surface 201 that the die 103 extends. In some implementations, the wing covers 210 are thinner than the die 103. The material of the wing covers can be selected so that it has a coefficient of thermal expansion (CTE) similar to the CTEs of the other components (e.g., the die 103) in the fluid ejector 100. Matching the CTE of the wing cover to other components in the fluid ejector can prevent movement between the wing cover and the other components. For example, matching the CTEs maintains the coplanarity between the nozzle surface of the die 103 and the bottom surface of the wing covers 210 when the temperature of the device increases or decreases.

In some implementations, the wing covers are formed of a material that has good chemical resistance and good mechanical properties, such as liquid crystal polymer (LCP). Selecting a suitable material for the wing covers can prevent damage to the wing covers during fluid ejection, particularly if the fluid is ejected at elevated temperatures or the fluid is corrosive. To improve the wiping capabilities of the wiper blades, the wing covers can be formed of a non-stick material. The non-stick material can include any suitable non-wetting material. One potential problem with certain types of non-wetting coatings used in combination with certain wing cover materials is that they can be easily removed by the wiper blade during the wiping process.

In some implementations, the wing covers can be polished or lapped (e.g., mirror finish) to achieve a smooth surface that is more non-wetting than if the surface had not been polished or lapped. Alternatively, the wing covers can be formed in a mold (e.g., injection-mold), and the mold can be polished so that the surfaces of the wing covers are smooth. Further, a non-wetting coating could be applied to the wing covers. Rather than forming a non-wetting coating on a surface, the wings can be formed of a material that itself forms non-wetting surfaces. Non-wetting surfaces are surfaces that have a contact angle between a deionized (DI) water and the surface that is greater than 90 degrees. Thus, some types of surfaces do not require a separate coating to make them non-wetting. That is, the surface can be inherently non-wetting without an additional layer of non-wetting material formed thereon.

In some implementations, non-wetting surfaces are formed by using a material that is inherently non-wetting and has a smooth surface. The non-wetting quality of a material, such as some types of moldable materials, such as a thermoset material (e.g., Kyocera KE-G4700), can be sufficient to prevent wetting of fluids on the material. In some embodiments, the thermoset itself is polished. Alternatively, the components, e.g., the wing covers, can be formed of a wetting material that has a smooth surface that has a non-wetting coating applied thereto. Materials such as glass can be wetting. In yet another alternative implementation, a non-wetting material with a smooth surface can have a non-wetting coating. For example, a smooth silicon layer can be used with a non-wetting coating. The contact angle between DI water and a silicon surface having a condensed FDTS non-wetting coating can be about 108 degrees while the contact angle between DI water and a smooth thermoset surface can be about 91 degrees. The wing covers can be formed from a variety of materials, including the aforementioned silicon, glass, and thermoset material, as well as quartz, metal, or ceramic (e.g., non-porous ceramic). Furthermore, the surfaces of the wing covers can be cleaned to enhance the non-wetting quality of the surfaces (e.g., doing an RCA cleaning).

In some implementations, the wing covers are formed of silicon and at least the bottom faces of the covers are coated with a non-wetting coating. The non-wetting coating tends to adhere well to the silicon material and is less susceptible to damage from the wiping blades. Further, silicon wing covers can be made very smooth, which further enhances the ability of the wiper blades to clean fluid from the wing covers. Polished silicon has a surface roughness of about less than 8 nanometers and thermoset material molded in a polished mold, such as the Kyocera KE-G4700 material mentioned above, is between about 33 and 35 nanometers.

The non-stick coating on the silicon wing covers can be a self-assembled monolayer, i.e., a single molecular layer. Such a non-wetting coating monolayer can have a thickness of about 5 to 30 Angstroms, such as about 10 to 20 Angstroms, e.g., about 15 Angstroms. Alternatively, the non-wetting coating can be a molecular aggregation. In a molecular aggregation, the molecules are separate but held in the aggregation by intermolecular forces, e.g., by hydrogen bonds and/or Van der Waals forces, rather than ionic or covalent chemical bonds. Such a non-wetting coating aggregation can have a thickness of about 30 to 1000 Angstroms. The increased thickness of the non-wetting coating make the non-wetting coating more durable and resistant to a wider range of fluids.

The molecules of the non-wetting coating can include one or more carbon chains terminated at one end with a —CF₃ group. The other end of the carbon chain can be terminated with a SiCl₃ group, or, if the molecule is bonded to a silicon oxide layer (not shown), terminated with a Si atom which is bonded to an oxygen atom of the silicon oxide layer (the remaining bonds of the Si atom can be filled with oxygen atoms that are connected in turn to the terminal Si atoms of adjacent non-wetting coating molecules, or with OH groups, or both). The carbon chains can be fully saturated or partially unsaturated. For some of the carbon atoms in the chain, the hydrogen atoms can be replaced by fluorine. The number of carbons in the chain can be between 3 and 10. For example, the carbon chain could be (CH₂)_{M}(CF₂)_{N}CF₃, where M≧2 and N≧0, and M+N≧2, e.g., (CH₂)₂(CF₂)₇CF₃.

The molecules of the non-wetting coating adjacent the nozzle layer wing cover, i.e., the monolayer or the portion of the molecular aggregation adjacent the substrate, can be a siloxane that forms a bond with oxides formed near the surface of the nozzle layer or with OH groups on the surface of the wing cover, both of which can be enhanced by O₂ plasma treatment, as discussed further below.

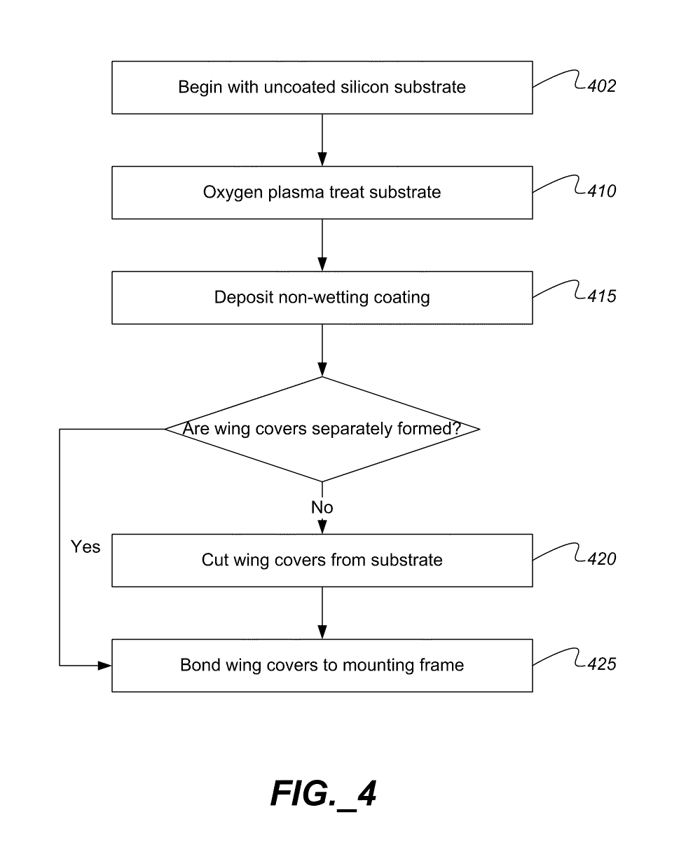

A process for forming the non-wetting coating on a wing cover begins, as shown FIG. 4, with a silicon substrate that is uncoated (step 402). Optionally, the silicon wing covers can be precut from the substrate. However, this step can also be preformed at the end of the process. The substrate can be formed of single-crystal silicon. In some implementations, a native oxide layer, i.e., silicon oxide, having a thickness, for example, of up to about 40 Å, such as about 20 Å to 30 Å, is present on the surfaces of the substrate. However, a native oxide layer tends to be porous and may form weak bonds with a non-wetting coating. Thus, the native oxide can be partially or wholly removed, leaving either a very thin native oxide layer, e.g., less than 10 Å thick, or a surface that is formed of substantially pure silicon. The native oxide layer can have a density of less than 2.0 g/cm³, such as 1.9 g/cm³.

The substrate is then subjected to oxygen (O₂) plasma treatment (step 410). The oxygen plasma treatment can be conducted, for example, in an anode coupling plasma tool, e.g., from Yield Engineering Systems, Livermore, Calif., a cathode coupling plasma or an inductively coupled plasma (ICP) tool. Thus, the substrate can be placed in a vacuum chamber and the pressure reduced to near vacuum, for example a pressure of less than 1 Torr, such as 0.2 Torr or 10⁻⁵ Torr. Oxygen can be introduced into the chamber, for example with a flow rate of 80 sccm. When RF power is initiated, such as at a power of 500 W, an O₂ plasma is formed. The O₂ plasma treatment can be conducted for between 1 minute and 90 minutes, such as 5 minutes to 60 minutes. Both the inner surface 150 and outer surfaces 160 of the fluid ejector can be exposed to the O₂ plasma.

The O₂ plasma treatment can densify an outer portion of the substrate. For example, the O₂ plasma can cause SiO₂ to form along the outer portion of the substrate to densify the outer portion. Further, the plasma can cause atoms from the walls of the chamber, such as aluminum atoms, to be removed from the walls and become embedded in the outer portion of the substrate to densify the outer portion. For example, AlOₓ can be embedded in the outer portion. The high density outer portion can be between about 10 Å and 90 Å thick, such as between 20 Å and 80 Å thick, for example between 20 Å and 50 Å thick. Further, the high density outer portion can have a density of greater than 2.5 g/cm³, for example 2.6 g/cm³, whereas the inner non-densified portions can have a density of less than 2.5 g/cm³, such as between 2.0 g/cm³ and 2.5 cm³, for example 2.33 g/cm³. Such a high density outer portion provides more oxide with which the non-wetting layer can bond, increasing the physical robustness of the nonwetting layer and thereby making the layer more resistant to mechanical wiping of the nozzle surface. The density of the material can be determined using x-ray reflectivity (XRR).

In addition, the O₂ plasma treatment can increase the number of —OH groups on the surface of the substrate. Increasing the number of —OH groups allows for good coverage of the non-wetting coating. That is, because the precursors for the non-wetting film bond with the —OH groups on the substrate, the greater number of —OH groups allows for better coverage by the non-wetting coating. The higher percentage of —OH groups can be verified using a time-of-flight secondary ion mass spectrometer (TOF-SIMS), such as one that uses Ga⁺ ions to detect the —OH groups. In some instances, the number of —OH groups on an O₂ plasma treated surface is twice is great as the number of —OH groups on a non-treated surface. The increased coverage of the non-wetting coating caused by the —OH groups increases the chemical robustness of the nonwetting coating, thereby making it more difficult for jetting fluid to penetrate the coating. The coverage of the film can be determined by x-ray photoelectron spectroscopy (XPS).

The non-wetting coating, e.g., a layer of hydrophobic material, is deposited on exposed surfaces of the substrate (step 415). The non-wetting coating can be deposited using vapor deposition, rather than being brushed, rolled, or spun on. In some implementations, parts of the wing cover can be masked to form a pattern of non-wetting coating on the wing.

The non-wetting coating can be deposited, for example, by introducing a precursor and water vapor into a chemical vapor deposition (CVD) reactor at a low pressure. The partial pressure of the precursor can be between 0.05 and 1 Torr (e.g., 0.1 to 0.5 Torr), and the partial pressure of the H₂O can be between 0.05 and 20 Torr (e.g., 0.1 to 2 Torr). The deposition temperature can be between room temperature and about 100 degrees centigrade. The coating process can be performed, by way of example, using a Molecular Vapor Deposition (MVD)™ machine from Applied MicroStructures, Inc., San Jose, Calif.

Suitable precursors for the non-wetting coating include, by way of example, precursors containing molecules that include a terminus that is non-wetting, and a terminus that can attach to a surface of the fluid ejector. For example, precursor molecules that include a carbon chain terminated at one end with a —CF₃ group and at a second end with an —SiCl₃ group can be used. Specific examples of suitable precursors that attach to silicon surfaces include tridecafluoro-1,1,2,2-tetrahydrooctyltrichlorosilane (FOTS) and 1H,1H,2H,2H-perfluorodecyl-trichlorosilane (FDTS). Other examples of non-wetting coatings include 3,3,3-trifluoropropyltrichlorosilane (CF₃(CH₂)₂SiCl₃) and 3,3,3,4,4,5,5,6,6-nonafluorohexyltrichlorosilane (CF₃(CF₂)₃(CH₂)₂SiCl₃). Without being limited by any particular theory, it is believed that when a precursor (such as FOTS or FDTS) whose molecules include an —SiCl₃ terminus are introduced into the CVD reactor with water vapor, the precursor undergoes hydrolysis, and then a siloxane bond is created so that silicon atoms from the —SiCl₃ groups bond with oxygen atoms from —OH groups on the surface of the substrate, such as the OH groups of the native oxide of the substrate, resulting in a coating, such as a monolayer, of molecules with the other, i.e. non-wetting, terminus exposed.

If the non-wetting coating is applied to a substrate, rather than pre-cut wing cover, the wing covers are then cut from the substrate (step 420). The wing covers can be cut from the silicon substrate, such as by dicing, e.g., sawing, plasma etching, or laser cutting. The individual wing covers are then bonded onto the mounting frame with a bonding material, such as with an epoxy or glue (step 425). In some implementations, a region between the die and the wing covers is backfilled with the bonding material. The backfill can ensure that there is no gap between the die and the wing covers. Thus, in some implementations the die, backfill and wing covers form a substantially smooth planar surface that is free of recesses, other than the nozzles. In some implementations, the coating step occurs after the wing covers are attached to the mounting frame. For example, the coating of the wing covers can occur simultaneous with coating the outer surface of the silicon die.

As an alternative to bonding the non-wetting coating to silicon wing covers, the non-wetting coating can be bonded to an oxide layer on the silicon wing covers. However, by bonding the non-wetting coating directly to silicon, rather than using an oxide adhesive layer (often having a thickness of up to 200 nm), erosion by aggressive inks, such as EPSON ink, for example T054220 cyan ink, can be avoided that would otherwise attack non-wetting coatings of the same material that are formed on an adhesive layer. The non-wetting coating can also be on the nozzle surface of the die. In some implementations, the wing cover has the same non-wetting coating and non-wetting characteristics as the nozzle surface of the die.

Referring to FIG. 5, once the wing covers are bonded onto the mounting frame, the assembly can be fit into a housing 510, such as with a plurality of similar assemblies (not shown). The housing 510 can then be placed into a printing device that includes wiper blades for cleaning the surface of the die and wing covers.

A number of implementations of the invention have been described. Nevertheless, it will be understood that various modifications may be made without departing from the spirit and scope of the invention. Accordingly, other implementations are within the scope of the following claims.

What is claimed is:

1. A fluid ejection device, comprising:
a mounting frame having a wing structure;
a fluid ejection die bonded to the mounting frame and adjacent to the wing structure, wherein the fluid ejection die has nozzles in a nozzle surface; and
a cover on the wing structure, wherein the cover has a surface with a non-wetting coating and the surface is co-planar with the nozzle surface of the die.

2. The fluid ejection device of claim 1, wherein the cover is adhered to the wing structure with a bonding agent.

3. The fluid ejection device of claim 1, wherein:
a gap between an edge of the die and the cover is filled with a filler; and
the filler, the nozzle surface of the die and the cover form a surface that is substantially planar.

4. The fluid ejection device of claim 1, wherein the mounting frame has two wing structures, a first of which is adjacent to a first edge of the die and a second of which is adjacent to a second edge of the die opposite to the first edge.

5. The fluid ejection device of claim 1, wherein the non-wetting coating is a different material than the cover.

6. The fluid ejection device of claim 5, wherein the cover is formed of silicon.

7. The fluid ejection device of claim 1, wherein the non-wetting coating includes one of tridecafluoro 1,1,2,2 tetrahydrooctyltrichlorosilane (FOTS), 1H,1H,2H,2H perfluorodecyl-trichlorosilane (FDTS), 3,3,3-trifluoropropyltrichlorosilane (CF₃(CH₂)₂SiCl₃) or 3,3,3,4,4,5,5,6,6-nonafluorohexyltrichlorosilane (CF₃(CF₂)₃(CH₂)₂SiCl₃).

8. A method of forming a fluid ejection device, comprising:
forming a non-wetting coating on a substrate;
bonding the substrate onto a mounting frame; and
bonding a die having a nozzle surface onto the mounting frame;
wherein a surface of the substrate on which the non-wetting coating is located and the nozzle surface of the die are substantially co-planar.

9. The method of claim 8, further comprising forming individual wing covers from the substrate prior to bonding the substrate onto the mounting frame.

10. The method of claim 8, wherein:
the substrate is a silicon substrate; and
forming a non-wetting coating on a substrate includes oxygen plasma treating the silicon substrate.

11. The method of claim 8, wherein forming a non-wetting coating on a substrate includes forming a coating from one of tridecafluoro 1,1,2,2 tetrahydrooctyltrichlorosilane (FOTS), 1H,1H,2H,2H perfluorodecyl-trichlorosilane (FDTS), 3,3,3-trifluoropropyltrichlorosilane (CF₃(CH₂)₂SiCl₃) or 3,3,3,4,4,5,5,6,6-nonafluorohexyltrichlorosilane (CF₃(CF₂)₃(CH₂)₂SiCl₃).

12. The method of claim 8, further comprising filling a gap between the die and the substrate with a filler to form a planar surface.

13. A method of using a fluid ejection device, comprising:
wiping a nozzle surface of a die with a wiper blade, wherein the nozzle surface is co-planar with a cover on a mounting frame in which the die is located and the cover has a non-wetting coating thereon.
